(19) United States
(12) Patent Application Publication
(10) Pub. No.: US 2018/0198881 A1
(43) Pub. Date: Jul. 12, 2018

(54) INTERFACE BETWEEN A WEAPONS SYSTEM AND A TACTICAL DATA LINK

(71) Applicant: MBDA FRANCE, Le Plessis-Robinson (FR)

(72) Inventor: Florent Michaux, Le Plessis-Robinson (FR)

(73) Assignee: MBDA FRANCE, Le Plessis-Robinson (FR)

(21) Appl. No.: 15/741,568

(22) PCT Filed: Jun. 23, 2016
(86) PCT No.: PCT/FR2016/000104

§ 371 Date: Jan. 3, 2018

(30) Foreign Application Priority Data
Jul. 8, 2015 (FR) 1501441

(51) Int. Cl. H04L 29/08; H04L 29/06

(52) U.S. Cl. CPC H04L 67/2823; H04L 69/08; H04L 67/12

(57) ABSTRACT

An interface which includes a modular data-management unit, comprising a first module and a second module that are linked together via a transmission link, the transmission link having a simplified standard copied from the standard of the data-transmission link, the first module being linked to a network of the weapons system and configured to translate a system message, received from the network, into a so-called intermediate message, and to translate an intermediate message, received via the transmission link, into at least one system message, the second module being linked to a communication unit and configured to encode an intermediate message received from the first module into a standard message of the tactical data link and to decode a standard message received and translate same into an intermediate message.

The present invention relates to an interface between a weapon system and at least one tactical data link.

It is known that a “tactical data link” (TDL) in the military sector implements data link standards in order to supply communication means by means of waveforms or wired connections. Information or combat systems use standardised tactical data links to transmit or receive tactical data. In France, J-series data links (L16 link, L22 link) currently represent one of the benchmark standards. Tactical data links are characterised by the standardised messages thereof and by the transmission formats. The standards of the tactical data links are developed in line with appropriate standardisation agreements (STANAG).

Furthermore, in the context of the present invention, the concept of a “weapon system” denotes all mechanical, electronic and/or software devices which allow the military to carry out a mission and implement weaponry in an autonomous manner (identifying, locating, designating an objective, preparing to fire, firing, guiding, etc.) or in a manner coordinated by means of a command and control centre (C2). Said system can be fixed on or put on board a land-based vehicle, a ship or an aircraft. Thus, weaponry is described as a weapon system when it integrates different equipment for operation (sensors, electronic devices, communication means, etc.).

Interfacing a weapon system with a tactical data link poses different problems linked in particular to the number and the complexity of the interfaces involved, and in particular:
a problem relating to operation. The definition of the data link standard defines both the type of information exchanged and the manner in which the information is used. This operation involves a potentially significant intersection between the functions of the command and control centre and the functions for managing the data link. The interfacing of a weapon system thus requires several types of function: operational functions required for creating the link between the missions of the system and the interface functions to be carried out, as well as communication and data link functions for implementing the link in a reliable and efficient manner. These functions are sometimes mixed, thus creating system interfaces which are ill-suited to the operational context, or unreliable data links; and
a problem in terms of managing configurations. The weapon system and the data link standard have their own life cycle. This poses problems in terms of the system engineering for managing the changes in the interfaces during the phases of design and of maintenance under operating conditions. In addition, the interoperability standard, as well as the different systems to which connections must be made, change during the life of the system. For these reasons, the interfacing of the weapon system necessitates regular changes.

The changes in current weapon systems are often problematic, and numerous weapon systems are rarely updated and use different versions of data links, which can create specific problems relating to interoperability.

The interface of the weapon system to the tactical data link is generally implemented by a software and hardware component, for example a component of the DLP (data link processor) type. The role of said component is to allow the system to send and receive messages from the data link. There are numerous designs for DLP components:
an integral DLP software carrying out all the data link functions and having a proprietary interface which can be complex in order to manage the redundancies between the similar functions which are found in the weapon system and the component; and
a DLP library which requires interfacing directly or almost directly with the core of the weapon system and which no longer allows configuration management of the weapon system which is separate from the data link thereof.

One of the major disadvantages of the conventional solutions is the lack of modularity thereof, as well as a mixture of the operational aspects and the technical aspects (data transmission). These solutions do not allow the system manufacturer (the company which designed the weapon system) to concentrate solely on their core competencies, that is to say the operational interfacing of their weapon system.

There are thus two possible arrangements:
First, the system manufacturer produces the DLP component in full. They must then develop and maintain the communication layer (often complex) for a greater cost than a specialist subcontractor would offer, which means that the costs are shared across all their clients;
Second, the system manufacturer purchases the integral solution, but no longer has total control over the operating information emitted by their system. The interface with the system is imposed thereon, and the integral component interprets and translates the information with risks of errors or problems.

These integral solutions can also be more difficult to change in order to take into account a change in a standard, a change in operational behaviour or even a change in communication means.

The present invention relates to an interface which is intended to remedy some of the above-mentioned disadvantages. The interface has at least some of the following advantages: it allows the developer of a weapon system to facilitate integrating and changing the tactical data links in the weapon system in order to gain scalability, whilst maintaining control of the weapon system, reducing costs, preserving the reliability of the link and building on the skills of tactical data link specialists.

The present invention relates to an interface between a weapon system and at least one tactical data link, said interface being configured to be linked both to a network of the weapon system and to a communication unit of a tactical data link which complies with a specific standard, said interface comprising a data management unit.

According to the invention, said data management unit is of the modular type and comprises a first module implementing at least one operational function and at least one second module implementing at least one communication function, said first and second modules being interlinked by means of a link referred to as a transmission link, and:
said transmission link has a simplified standard which is derived directly from the standard of the data transmission link;
said first module is capable of being linked to said network of the weapon system and is configured:
   to translate a message referred to as a system message, received from said network, into a message referred to as an intermediate message, before transmission by the transmission link to said second module;
   to translate an intermediate message received by means of the transmission link into at least one system message, before transmission to said network; and
said second module is capable of being linked to the communication unit and is configured:
   to encode an intermediate message received from said first module into a standard message of the tactical data link, before transmission to said communication unit; and
   to decode a received standard message and to translate said message into an intermediate message, before transmission to said first module.

Thus, by means of the invention, an interface is obtained which has a modular architecture which separates the operational function(s) from the communication function(s) (or data transmission function(s)), as specified below. More specifically, the first module carries out the operational functions. It compiles the information to be emitted and directs the information received. The developer of the weapon system thus maintains total control of the messages sent, whilst subcontracting the data transmission functions (implemented by the second module) which are not part of their core competencies. This modular and scalable architecture limits the impact of a modification to a(n operational or communication) function in one module on the other module and makes it easier to completely replace the second module.

Advantageously, said first module is configured to:
apply first predetermined rules of system message emission;
carry out an operational selection of the information to be transmitted by the transmission link;
verify the operational consistency of an intermediate message received by means of the transmission link.

Furthermore, advantageously, said first module implements at least one translation rule in emission and at least one translation rule in reception, the translation rule in emission specifies the correspondence between fields of a system message and fields of an intermediate message, as well as the conversion type, and the translation rule in reception specifies the correspondence between fields of an intermediate message and fields of one or more system messages.

Furthermore, advantageously, said second module is configured to:
apply second predetermined rules of message emission;
manage the emission rate;
verify the formatting of messages received from the tactical data link.

In a preferred embodiment, said transmission link is determined according to a tactical data link of one of the following types:
a L16 link;
a L11 link;
a L22 link.

Furthermore, in a specific embodiment, the interface comprises a single first module and at least two second modules, each of which is linked to said first module by means of a transmission link. In a specific embodiment, the transmission link is a multi-protocol generic link. A multi-protocol generic link of this type is thus compatible with the invention.

Furthermore, in a first variant, the interface comprises at least two hardware elements, the first module being integrated in one of said hardware elements, and the second module being integrated in the other of said hardware elements.

Furthermore, in a second variant, the interface comprises a hardware element, the first and second modules both being integrated in said hardware element.

The present invention also relates to a weapon system which comprises at least one interface of the type described above.

The present invention further relates to a method for interfacing between a weapon system and at least one tactical data link to produce an interface between both a network of the weapon system and a communication unit of the tactical data link which complies with a specific specification (standard or proprietary).

According to the invention, said method comprises:
a first step implemented in a first module carrying out at least one operational function and capable of being linked to said network of the weapon system, the first step consisting:
   in a direction leaving the weapon system, in translating a message referred to as a system message, received from said network of the weapon system, into a message referred to as an intermediate message, before transmission by a transmission link to a second module, said transmission link having a simplified standard which is derived directly from the standard of the data transmission link; and
   in a direction entering the weapon system, in translating an intermediate message received by means of the transmission link into a system message, before transmission to said network; and
a second step implemented in the second module carrying out at least one communication function and capable of being linked to the communication unit, the second step consisting:
   in a direction leaving the weapon system, in encoding an intermediate message received from said first module into a message which is adapted to the communication unit of the tactical data link, before transmission to said communication unit; and
   in a direction entering the weapon system, in decoding a received standard message and translating said message into an intermediate message, before transmission to said first module.

The accompanying drawings will show how the invention can be carried out. In these drawings, identical reference numerals denote similar elements.

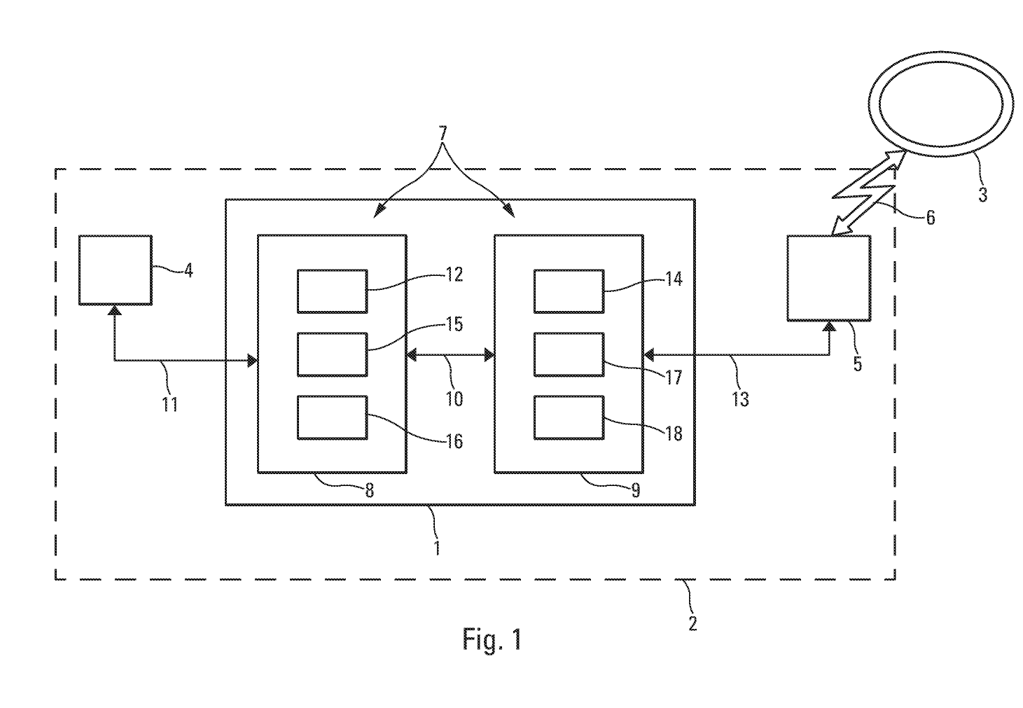

FIG. 1 is a block diagram of an interface according to a preferred embodiment of the invention.

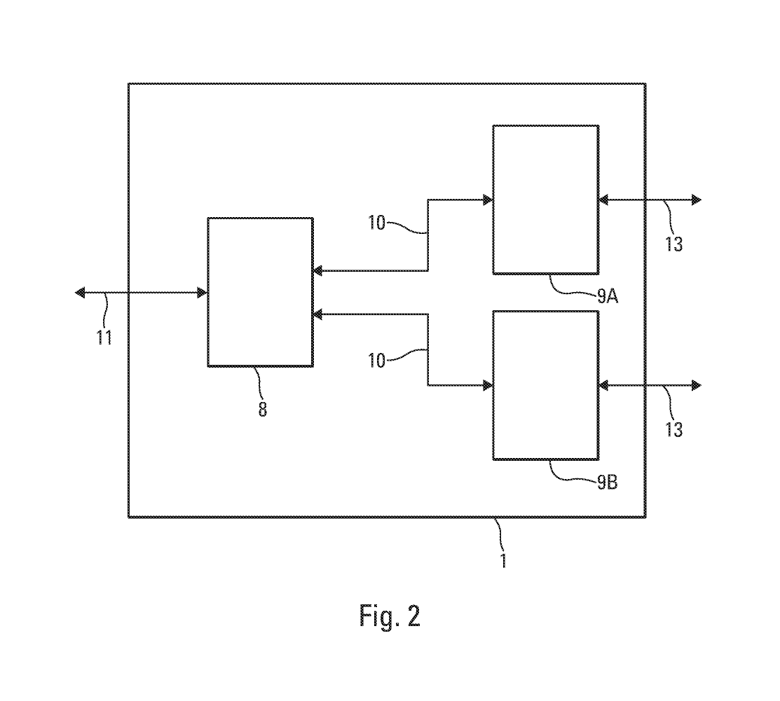

FIG. 2 is a block diagram of a specific embodiment of an interface.

The interface 1 illustrating the invention and shown schematically in FIG. 1 is intended to create a two-way link between a weapon system 2 and at least one tactical data link 3 shown schematically, which complies with a specific standard (or standard protocol), as specified below.

More specifically, said interface 1 is configured to be linked both to a network 4 of the weapon system 2 and to a communication unit 5 which is capable of communicating with the tactical data link 3, as shown by an arrow 6.

The interface 1, the network 4 and the communication means 5 are on board the weapon system 2. The interface 1 comprises a data management unit 7.

According to the invention, said data management unit 7 is of the modular type and comprises a first module 8 and at least one second module 9 which are interlinked by means of a link 10 referred to as a transmission link.

In addition, according to the invention:
the transmission link 10 has a simplified standard which is derived directly from the standard (for example L16 link) of the data transmission link 3. “Derived directly” (or “reproduced”) is understood to mean that the transmission link 10 is a simplified link, based on the standard of the data transmission link 3, of which only the necessary features have been preserved, as specified below;
the module 8 (for example a module referred to as “high”) implements one or more operational functions, it is capable of being linked to the network 4 of the weapon system 2, as illustrated by a link 11, and it comprises a translation unit 12 which is configured:
   to translate a message referred to as a system message, received from the network 4 (by means of the link 11), into a message referred to as an intermediate message, before transmission by the transmission link 10 to the module 9; and
   to translate an intermediate message received by means of the transmission link 10 into at least one system message, before transmission (by means of the link 11) to the network 4; and
the module 9 (for example a module referred to as “low”) implements one or more communication functions, it is capable of being linked to the communication unit 5, as illustrated by a link 13, and it comprises an encoding/decoding unit 14 which is configured:
   to encode an intermediate message received from the module 8 (by means of the transmission link 10) into a standard message of the tactical data link, before transmission to the communication unit 5 (by means of the link 13), and
   to decode a standard message received (by means of the link 13) and translate said message into an intermediate message, before transmission to the module 8 (by means of the transmission link 10).

Each of the modules 8 and 9 can be a component of a DLP (data link processor).

In the context of the present invention:
the weapon system 2 represents an assembly of mechanical, electronic and/or software devices allowing the military to carry out a mission and implement weaponry. Said system can be fixed on or put on board a land-based vehicle, a ship or an aircraft;
the network 4 of the weapon system 2 comprises a data processing, calculation and/or control unit which implements conventional algorithms to control the weapon system. Generally, said network 4 represents the core of the weapon system and makes it possible to interact with all the functions of the weapon system, for example the management of the tactical situation, the states of the subsystems, the arming commands, etc.;
the communication unit 5 corresponds to any type of conventional communication means which makes it possible to communicate, by means of a wired or radio link 6 for example, with the tactical data link 3;
an operational function is a function carried out by the weapon system 2, relating to the operation and the implementation of the weapon system 2;
a communication or data transmission function is a function relating to the management and to the implementation of data transmission.

With this architecture of the interface 1 comprising two separate modules 8 and 9, the tasks of creating the content of a message (implemented by the module 8) are decorrelated from the tasks of formatting and transmitting the message (implemented by the module 9). It is thus planned, from a DLP library, to add a standardised and simplified interface 1 between functions (in the module 8) which have a strong link to the (operational) weapon system and functions (in the module 9) which have a benefit that relates solely to the (technical) data link.

In order to allow the transmission of all possible information by means of the standard data link (for example a L16 link) and to avoid interpretation errors on the part of the module 9, a selection of useful fields is not carried out: there is a 1-to-1 correspondence between the standard messages and the intermediate messages.

Furthermore, so as to be easy to implement and decode, the transmission link 10 (for the intermediate messages) is relieved of the encoding constraints of the standard. The information is encoded into a conventional computing type (int, double, char, etc.) and into SI units.

The transmission link 10 is asynchronous and bidirectional. Said link is not constrained in terms of emission rate or synchronisation (each component emits information when desired).

The interface 1 is thus configured to make it possible to transmit all useful information, to be easy to integrate, and to make changes.

The interface 1 allows the developer of the weapon system 2 to facilitate integrating and changing the tactical data links in the weapon system 2 in order to gain scalability, whilst maintaining control of the weapon system 2, reducing costs, preserving the reliability of the link and building on the skills of tactical data link specialists.

The module 8 of the interface 1 thus ensures the translation between the system messages and the intermediate messages, and vice versa. The relationship between system messages and intermediate messages is not one-to-one.

The module 8 is configured to apply first predetermined rules of system message emission corresponding to the emission policy (when to send a message, what message to send with what content), according to the state of the system and the system messages received.

Furthermore, the module 8 comprises a selection unit 15 which carries out an operational selection of the information to be transmitted by means of the transmission link 10. Said selection unit 15 also carries out synthesis of the states of the system.

The module 8 also comprises a verification unit 16 which, during reception, verifies the operational consistency of a message (completion of the data to be interpreted correctly by the system, consistency of the data of the message) and translates the message into one or more system messages. The verification of the consistency of the data can consist in verifying fields which must be filled and fields with a range of permissible values. These verifications can be conditional on a field being filled (if a field X is completed, then a field Y must also be completed).

In addition, the module 8 implements rules for translation in emission and rules for translation in reception. A translation rule in emission specifies the correspondence between fields of a system message and fields of an intermediate message, as well as the conversion type. In addition, a translation rule in reception specifies the correspondence between fields of an intermediate message and fields of one or more system messages. A plurality of conversion rules can be specified on the basis of a state or of a specific value of a field.

Furthermore, the module 9 of the interface 1 thus translates the intermediate messages into standard messages (STANAG) by means of the encoding/decoding unit 14. The relationship between the intermediate messages and the standard messages is one-to-one.

The module 9 connects to the communication unit 5 (radio, router, etc.) whilst observing a standard protocol (STANAG, for example SIMPLE, JREAP, etc.) or proprietary protocol.

The module 9 comprises a management unit 17 which manages the connection rate (type of messages, subsampling of messages, management of priorities, etc.). Said module applies rules of message emission which correspond to the emission policy selected by the operator. In the case of the JREAP protocol (joint range extension applications protocol), the module 9 simulates the communication unit by emitting machine acknowledgements of receipt.

The module 9 also comprises a verification unit 18 which, in reception, verifies the correct formatting of the messages.

In a preferred embodiment, said transmission link 10 is reproduced (whilst being simplified) on a standard tactical data link (which is complex), preferably of one of the following types:
a L16 link (J-series);
a L11 link (M-series);
a L22 link (J-series).

Of course, this list of possible tactical data links is not exclusive.

In a preferred embodiment, the tactical data link considered is a L16 link. The L16 link is a NATO tactical data link standard for exchanging tactical information between military units. The content of the messaging thereof and the emission protocol are defined by STANAG 5516 for NATO. The operational implementation thereof is defined in the document NATO ADatP 33, which is a set of procedures allowing the implementation of a network of multi-link tactical data links, and ADatP 16, which is specific to the L16 link.

To create the intermediate messages (relating to the L16 standard for example), the interface 1 (and in particular the module 9) takes into account the following features:
physical values (LSB, etc.): double SI unit;
listed: “short”, L16 encoding;
characters (TN, VCS, etc.): “char string”;
listed Boolean: “short” (Boolean);
listed hybrid (physical values with LSB +listed, for example “voice frequency channel”): “short” with L16 encoding, no conversion; and
“switch” (listed indicating which field is active). All possible fields are included in the intermediate message (listed and possible fields).

The details of the composition of the intermediate messages can change according to the requirements and constraints of the weapon system. Thus, some of the above rules can be modified. In particular, it is possible to provide for:
the selection of only some of a standard message, by removing the parts which are completely useless to the system;
the use of a non-SI unit, for example to avoid unnecessary double conversions; and
the addition of constraints on flow rate on the intermediate link. This addition may be necessary if the flow rate of the system messages is too high.

The interface 1, as described above, thus has a modular architecture which separates the operational functions from the communication (or transmission) functions. More specifically, the module 8 carries out the operational functions. It compiles the information to be emitted and directs the information received. The developer of the weapon system thus maintains total control of the messages sent, whilst subcontracting the data transmission functions (implemented by the module 9) which are not part of their core competencies. This modular and scalable architecture limits the impact of a modification to a(n operational or communication) function in a module 8, 9 on the other module 9, 8, and makes it easier to completely replace the module 8 or 9.

The interface 1 thus makes it possible to:
easily change the behaviour of the weapon system 2 on the tactical data link, without constraints linked to the aspects of communication; and
easily change the standards or communication means 15 without impacting the weapon system 2.

The interface 1 is thus simple and easy to implement.

Said interface is easily scalable in order to adhere to the modifications to the components. It concentrates on the content of the message, but without having ambiguities which necessitate interpretations of the module 9 (transmission of the information).

In a specific embodiment shown in FIG. 2, the interface 1 comprises a single module 8 and at least two modules 9A and 9B, each of which is linked to said module 8 by means of a transmission link 10.

In this case, the interface 2 can be used to connect the weapon system 2 to a plurality of different tactical data links (by means of said modules 9A and 9B). The module 8 then manages a plurality of data links and processes the messages according to the requirements of the weapon system 2 (with a possible adaptation in real time). The different transmission links 10 are designed in the same way and can share the same communication means.

Furthermore, in a first variant (not shown), the interface 1 comprises at least two hardware elements. The module 8 is integrated in one of said hardware elements, and the module 9 is integrated in the other of said hardware elements.

Furthermore, in a second variant (not shown), the interface 1 comprises a hardware element. The modules 8 and 9 are both integrated in this same hardware element.

The software interface of the interface 1 is not imposed. Said interface can be produced by means of a conventional network connection (UDP, TCP, etc.) in order to distribute the software components over different machines or even in order to integrate one of the DLP components by means of the API or even integrate source code, the interface then being an interface of software functions.

1. An interface between a weapon system and at least one tactical data link, said interface being configured to be linked on the one hand to a network of the weapon system and on the other hand to a communication unit of a tactical data link according to a particular standard, said interface comprising a data management unit,
wherein said data management unit is of modular type and comprises a first module using at least one operational function and at least a second module using at least one communication function, said first and second modules being linked together over said transmission link, and wherein:
said transmission link has a simplified standard derived directly from the standard of the data transmission link;
said first module is capable of being connected to said network of the weapon system and is configured:
to translate a system message, received from said network, into an intermediate message, before transmission over the transmission link to said second module; and
to translate an intermediate message, received from the transmission link into at least one system message, before transmission to said network; and
said second module is capable of being linked to the communication unit and is configured:
to encode an intermediate message received from said module into a standard message of the tactical data link, before transmission to said communication unit; and
to decode a received standard message and translate it into an intermediate message, before transmission to said first module.

2. The interface according to claim 1, wherein said first module is configured to apply the first predetermined rules of system message transmission.

3. The interface according to claim 1, wherein said first module is configured to produce an operational selection of the information to be transmitted by the transmission link.

4. The interface according to claim 1, wherein said first module is configured to carry out a verification of operational consistency of an intermediate message received from the transmission link.

5. The interface according to claim 1, wherein said first module implements at least one translation rule in transmission and at least one translation rule in reception, wherein this translation rule in transmission specifies the correspondence between the fields of a system message and the fields of an intermediate message, as well the type of conversion, and wherein the translation rule in reception specifies the correspondence between the fields of an intermediate message and the fields of one or several system messages.

6. The interface according to claim 1, wherein said second module is configured to apply the first predetermined rules of system message transmission.

7. The interface according to claim 1, wherein said second module is configured to manage the transmission flow.

8. The interface according to claim 1, wherein said second module is configured to verify the formatting of messages received from the tactical data link.

9. The interface according to claim 1, wherein said transmission link is determined according to a tactical data link of one of the following types:
an L16 link;
an L11 link; and
an L22 link.

10. The interface according to claim 1, wherein said transmission link is a multi-protocol generic link.

11. The interface according to claim 1, comprising a single first module and at least two second modules, each of which is linked to said first module by a transmission link.

12. The interface according to claim 1, comprising at least two material elements, the first module being integrated in one of these material elements and the second module being integrated in the other of these material elements.

13. The interface according to claim 1, comprising one material element, the first and second modules being both integrated in this material element.

14. A weapon system comprising at least one interface specified in claim 1.

15. A method of interfacing between one weapon system and at least one tactical data link, to produce an interface between on the one hand a network of the weapon system and on the other hand a communication unit of the tactical data link which complies with a particular standard, comprising:
a first step implemented in a first module producing at least one operational function and capable of being linked to said network of the weapon system, the first step comprising:
in a direction leaving the weapon system, in translating a system message, received from said network of the weapon system, into an intermediate message, before transmission by a transmission link to a second module, said transmission link having a simplified standard derived directly from the standard of the data transmission link; and
in a direction entering the weapon system, in translating an intermediate message received from the transmission link into a system message, before transmission to said network; and
a second step implemented in the second module producing at least one communication function and capable of being linked to the communication unit, the second step comprising:
in a direction leaving the weapon system, in encoding an intermediate message received from said fist module into a standard message of the tactical data link, before transmission to said communication unit; and
in a direction entering the weapon system, in decoding a received standard message and translating it into an intermediate message, before transmission to said first module.
